(19) United States
(12) Patent Application Publication
(10) Pub. No.: US 2016/0276781 A1
(43) Pub. Date: Sep. 22, 2016

(54) SHIELDING SHELL AND ELECTRICAL CONNECTOR THEREOF

(71) Applicant: Yong Tai Electronic (DONGGUAN) Ltd., Dongguan City (CN)

(72) Inventor: CHING-JEN HSU, Dongguan (CN)

(21) Appl. No.: 15/074,167

(22) Filed: Mar. 18, 2016

(30) Foreign Application Priority Data
Mar. 20, 2015 (CN) 201520159935.4

(51) Int. Cl. H01R 13/6581

(52) U.S. Cl. CPC H01R 13/6581

(57) ABSTRACT

A rear shielding shell comprised of two halves is provided. Each half comprises a base portion, two opposite side portions smoothly extending away from both sides of the base portion, two shoulder portions, a collar portion, a first rear abutment and a second rear abutment. The two halves are combined with each other by hermaphroditic features inside outer surfaces thereof. The two shoulder portions extend away from rear ends of both the base portion and the two opposite side portions. The collar portion outwardly protrudes from and between the two shoulder portions. The first and second rear abutment are formed at somewhere adjacent to the two shoulder portions by inwardly protruding from inner surfaces at the two opposite side portions respectively, wherein the base portion, the two opposite side portions, the first rear abutment and the second rear abutment are shaped as a curved arch on the whole.

### CROSS-REFERENCE TO RELATED APPLICATIONS

The present application claims the benefit of priority to Chinese patent application No. 201520159935.4, which was filed on Mar. 20, 2015 and is hereby incorporated by reference in its entirety.

### FIELD OF THE INVENTION

The present invention generally relates to a shell and a connector thereof, and more particularly to a shielding shell and an electrical connector thereof.

### BACKGROUND OF THE INVENTION

It is common in data connection systems to provide an electrical connector of a reversible configuration where the electrical connector includes a shielding shell surrounding electrical contacts, where the shielding shell is provided for EMI/RFI protection and must be connected to the shielding wires of a cable to be terminated to the electrical connector. Typically, the electrical connector is placed within a stamped and formed metal or a cast metal housing comprised of front and rear shielding shells.

It is desirable to make a strong structure and have an effective electrical contact between the shielding shells and both the individual shield on the connector as well as to the shielding wires. These shielding shells are typically used as the common link between the shielding wires and the individual shield on the electrical connector. However, it is difficult to provide such an electrical connection with the presently available technology, and at the same time provide an easily installable connection assembly.

### SUMMARY OF THE PRESENT INVENTION

According to one aspect of the present invention, a rear shielding shell for surrounding a cable and holding a retention feature of a front shielding shell, wherein the front shielding shell is fitted over a dielectric module in which a plurality of contacts are embedded and the cable are electrically connected to the plurality of contacts via a paddle card, is provided. The rear shielding shell is comprised of two halves and each half comprises a base portion, two opposite side portions, two shoulder portions, a collar portion, a retaining portion, a first rear abutment and a second rear abutment. The two opposite side portions smoothly extend away from both sides of the base portion, wherein the two halves are combined with each other by hermaphroditic features inside outer surfaces thereof. The two shoulder portions extend away from rear ends of both the base portion and the two opposite side portions. The collar portion by which the cable is surrounded outwardly protrudes from and between the two shoulder portions. The first rear abutment and the second rear abutment are formed at somewhere adjacent to the two shoulder portions by inwardly protruding from inner surfaces at the two opposite side portions respectively, wherein the base portion, the two opposite side portions, the first rear abutment and the second rear abutment are shaped as a curved arch on the whole. The retaining portion engages with the retention feature of the front shielding shell.

According to the rear shielding shell mentioned above, each half the rear shielding shell further comprises a first notch and a second notch, wherein the first notch and the second notch are respectively cut in the first rear abutment and the second rear abutment and through the two opposite side portions.

According to the rear shielding shell mentioned above, each half the rear shielding shell further comprising a first rear recess and a second rear recess, wherein the first rear recess and the second rear recess are provided by reducing the thickness of the two opposite side portions from the outer surfaces at the first rear abutment and the second rear abutment.

According to the rear shielding shell mentioned above, the second rear recess is provided with a rear slit by further removing the opposite side portion at the second rear abutment.

According to the rear shielding shell mentioned above, each half the rear shielding shell further comprises a first front recess and a second front recess, wherein the first front recess and the second front recess are provided by reducing the thickness of the two opposite side portions from the outer surfaces at the retaining portion.

According to the rear shielding shell mentioned above, the second front recess is provided with a front slit by further removing the opposite side portion.

According to the rear shielding shell mentioned above, the rear shielding shell are two substantially identical halves and each half includes the hermaphroditic features.

According to the rear shielding shell mentioned above, the hermaphroditic features include an alignment pin and an alignment hole, wherein the alignment pin and the alignment hole are interchangeably formed at the first rear abutment and the second rear abutment.

According to the rear shielding shell mentioned above, the hermaphroditic features include an alignment rib and an alignment groove, wherein the alignment rib protrudes from the coupling surfaces on one of the two opposite side portions while the alignment groove is correspondingly provided on the coupling surfaces on the other of the two opposite side portions.

According to the rear shielding shell mentioned above, the alignment rib leans against the first rear abutment or the second rear abutment of other half the rear shielding shell.

According to another aspect of the present invention, an electrical connector is provided. The electrical connector comprises a dielectric module, a plurality of contacts, a front shielding shell, a cable and a rear shielding shell. The plurality of contacts are embedded in the dielectric module. The plurality of contacts are embedded in the dielectric module. The front shielding shell is fitted over the dielectric module. The cable is electrically connected to the plurality of contacts via a paddle card. The rear shielding shell is comprised of two halves and each half comprises a base portion, two opposite side portions, two shoulder portions, a collar portion, a retaining portion, a first rear abutment and a second rear abutment. The two opposite side portions smoothly extends away from both sides of the base portion, wherein the two halves are combined with each other by hermaphroditic features inside outer surfaces thereof. The two shoulder portions extend away from rear ends of both the base portion and the two opposite side portions. The collar portion by which the cable is surrounded outwardly protrudes from and between the two shoulder portions. The first rear abutment and the second rear abutment are formed at somewhere adjacent to the two shoulder portions by inwardly protruding from inner surfaces at the two opposite side portions respectively, wherein the base portion, the two opposite side portions, the first rear abutment and the second rear abutment are shaped as a curved arch on the whole. The retaining portion engages with the retention feature of the front shielding shell.

According to the electrical connector mentioned above, each half the rear shielding shell further comprises a first notch and a second notch, wherein the first notch and the second notch are respectively cut in the first rear abutment and the second rear abutment and through the two opposite side portions.

According to the electrical connector mentioned above, each half the rear shielding shell further comprising a first rear recess and a second rear recess, wherein the first rear recess and the second rear recess are provided by reducing the thickness of the two opposite side portions from the outer surfaces at the first rear abutment and the second rear abutment.

According to the electrical connector mentioned above, the second rear recess is provided with a rear slit by further removing the opposite side portion at the second rear abutment.

According to the electrical connector mentioned above, each half the rear shielding shell further comprises a first front recess and a second front recess, wherein the first front recess and the second front recess are provided by reducing the thickness of the two opposite side portions from the outer surfaces at the retaining portion.

According to the electrical connector mentioned above, the second front recess is provided with a front slit by further removing the opposite side portion.

According to the electrical connector mentioned above, the rear shielding shell are two substantially identical halves and each half includes the hermaphroditic features.

According to the electrical connector mentioned above, the hermaphroditic features include an alignment pin and an alignment hole, wherein the alignment pin and the alignment hole are interchangeably formed at the first rear abutment and the second rear abutment.

According to the electrical connector mentioned above, the hermaphroditic features include an alignment rib and an alignment groove, wherein the alignment rib protrudes from the coupling surfaces on one of the two opposite side portions while the alignment groove is correspondingly provided on the coupling surfaces on the other of the two opposite side portions.

According to the electrical connector mentioned above, the alignment rib leans against the first rear abutment or the second rear abutment of other half the rear shielding shell.

Other advantages and novel features of the invention will become readily apparent from the following detailed description when taken in conjunction with the accompanying drawings.

### BRIEF DESCRIPTION OF THE DRAWINGS

FIG. 1 is a perspective view of an electrical connector according to the first embodiment of the present invention.

FIG. 2 is an exploded view of an electrical connector according to the first embodiment of the present invention.

FIG. 3 is a perspective view of a rear shielding shell according to the first embodiment of the present invention.

FIG. 4 is an exploded view of a rear shielding shell according to the first embodiment of the present invention.

FIG. 5 is another exploded view of a rear shielding shell according to the first embodiment of the present invention.

FIG. 6 is a perspective view of an electrical connector according to the second embodiment of the present invention.

FIG. 7 is an exploded view of an electrical connector according to the second embodiment of the present invention.

FIG. 8 is another exploded view of an electrical connector according to the second embodiment of the present invention.

FIG. 9 is an exploded view of a rear shielding shell according to the second embodiment of the present invention.

FIG. 10 is another exploded view of a rear shielding shell according to the second embodiment of the present invention.

FIG. 11 is a cross-sectional view of a rear shielding shell according to the second embodiment of the present invention.

FIG. 12 is another cross-sectional view of a rear shielding shell according to the second embodiment of the present invention.

FIG. 13 is another cross-sectional view of half a rear shielding shell according to the second embodiment of the present invention.

### DETAILED DESCRIPTION OF THE INVENTION

The present invention will now be described in detail with reference to embodiments thereof as illustrated in the accompanying drawings. While same or similar reference numerals or characters designate like parts or elements in different figures, doing so does not mean figures including same or similar reference numerals or characters constitute a single or same embodiment.

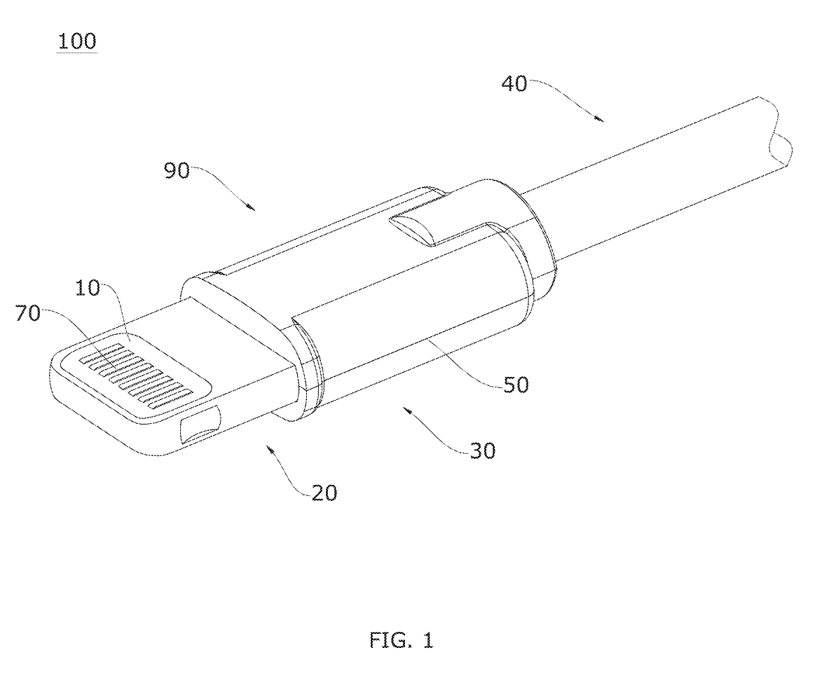

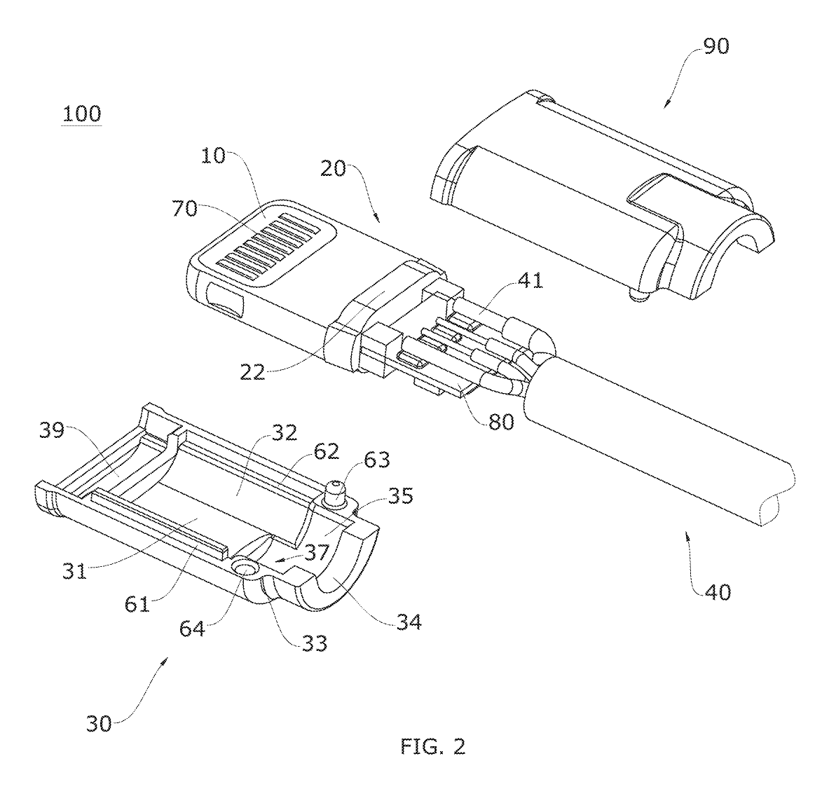

In order to better appreciate and understand the present invention, reference is first made to FIGS. 1-2, which are perspective and exploded views of an electrical connector 100 according to the first embodiment of the present invention. The electrical connector 100 includes an dielectric module 10 surrounded by a front shielding shell 20 as well as a rear shielding shell comprised of two halves 30 & 90. In this embodiment, the rear shielding shell comprised of two halves 30 & 90 are hermaphroditic, as shall be described in detail below, and fabricated of die cast material, such as a zinc alloy. However, in other embodiments, the two halves 30 & 90 can respectively be male and female.

The electrical connector 100 further includes a plurality of contacts 70 and a paddle card 80. The plurality of contacts 70 are embedded in the dielectric module 10 while forward wires 41 of a cable 40 are terminated to the paddle card 80. Via the paddle card 80, the forward wires 41 of the cable 40 are electrically connected to the plurality of contacts 70. The front shielding shell 20 is fitted over and attached to the dielectric module 10.

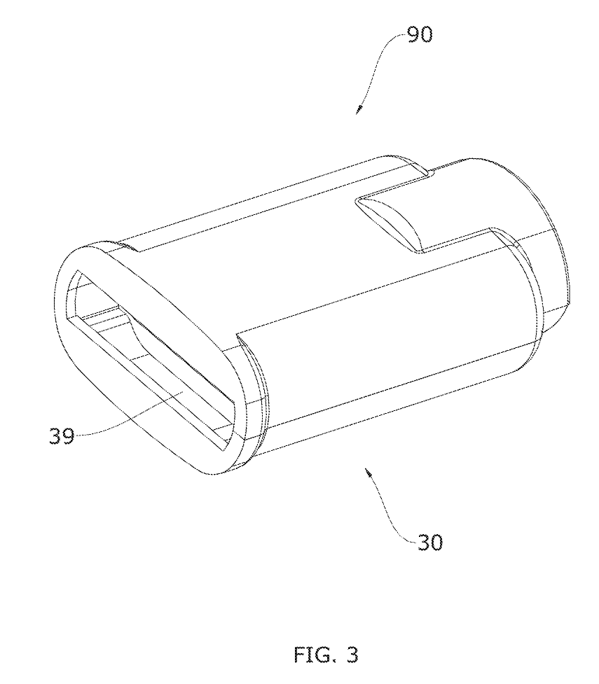

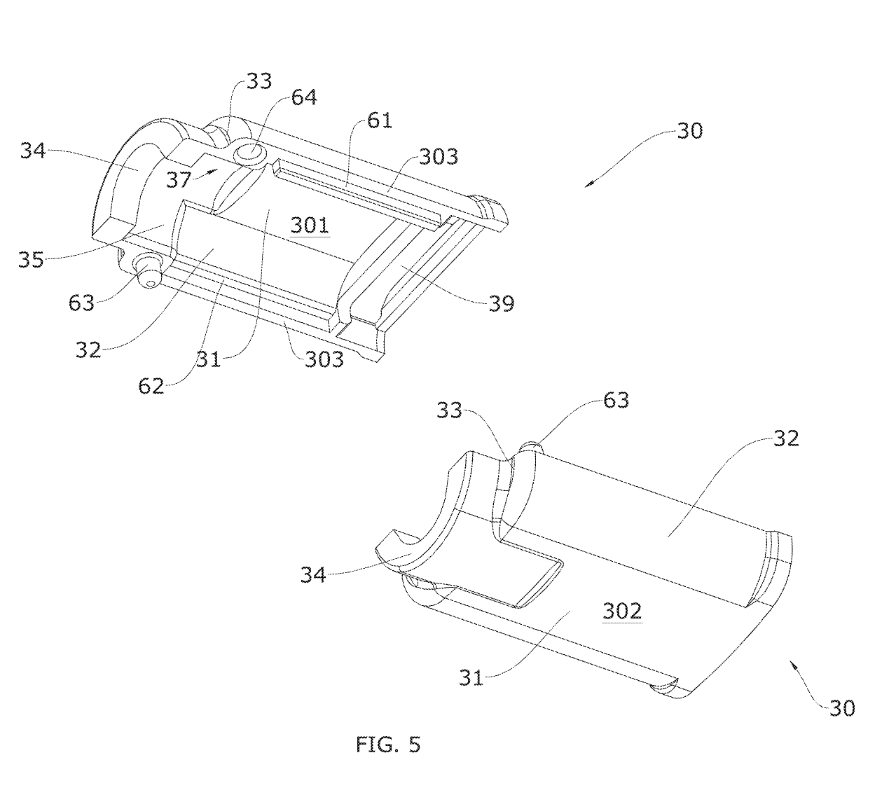

Reference is then made to FIGS. 3-5 in conjunction with FIG. 2, which are perspective and exploded views of the rear shielding shell comprised of two halves 30 & 90 according to the first embodiment of the present invention. It should be appreciated that in this embodiment, the two halves 30 & 90 are substantially identical and each half includes corresponding hermaphroditic features, therefore only half the rear shielding shell 30 will be described in detail. Possessing inner surfaces 301 and outer surfaces 302, half the rear shielding shell 30 includes a base portion 31, two opposite side portions 32, two shoulder portions 33 and a collar portion 34. The two opposite side portions 32 smoothly extend away from both sides of the base portion 31. The base portion 31 along with the two opposite side portions 32 are shaped as a curved arch on the whole. As a result of this, pinching or even treading forces from a user can be resolved into compressive stresses and, in turn eliminating tensile stresses. The two shoulder portions 33 extend away from rear ends of both the base portion 31 and the two opposite side portions 32. The collar portion 34 outwardly protrudes from and between the two shoulder portions 33. The cable 40 is surrounded by a pair of the collar portions 34 when the two halves 30 & 90 are assembled.

When the two halves 30 & 90 are assembled, a coupling plane in which seams 50 between the two substantially identical halves lie is defined. Half the rear shielding shell 30 further possesses coupling surfaces 303 which will substantially lie on the coupling plane when the two halves 30 & 90 are assembled. A first rear abutment 35 and a second rear abutment 37 are formed at somewhere adjacent to the two shoulder portions 33 by inwardly protruding from the inner surfaces 301 at the two opposite side portions 32 respectively. In this embodiment, both the first rear abutment 35 and the second rear abutment 37 are cornered. Moreover, the base portion 31, the two opposite side portions 32, the first rear abutment 35 and the second rear abutment 37 are shaped as a curved arch on the whole. Consequently, pinching or even treading forces from a user in the rear shielding shell are carried to the base, that is, the coupling surfaces 303. The rear shielding shell comprised of two halves 30 & 90 will push outward at the base, called thrust.

A retaining portion 39 which engages with retention features 22 of the front shielding shell 20 is provided. In this embodiment, the retaining portion 39 is a trough 39 as the retention features 22 are two flanges 22 at the rear of the front shielding shell 20. The two halves 30 & 90 are combined with each other such that the two flanges 22 is hold in the trough 39. In this embodiment, the hermaphroditic features include, as by molding, an alignment rib 61, an alignment groove 62, an alignment pin 63 and an alignment hole 64. The alignment rib 61 protrudes from the coupling surfaces 303 on one of the two opposite side portions 32, while the alignment groove 62 is correspondingly provided on the opposite side, that is, the coupling surfaces 303 on the other of the two opposite side portions 32. The alignment rib 61 will engage with the alignment rib 61 of other half the rear shielding shell 90 when assembled. Subsequently, the thrust at the coupling surfaces 303 will be restrained by the alignment rib 61 and the alignment groove 62 inside the outer surfaces 302. Half the rear shielding shell 30 with hermaphroditic features integrated into itself by molding makes it possible to secure the two halves 30 & 90 in perfect alignment and in secure relation against relative lateral or endwise shift there-between. In other words, the two halves 30 & 90 are combined with each other by hermaphroditic features inside the outer surfaces 302.

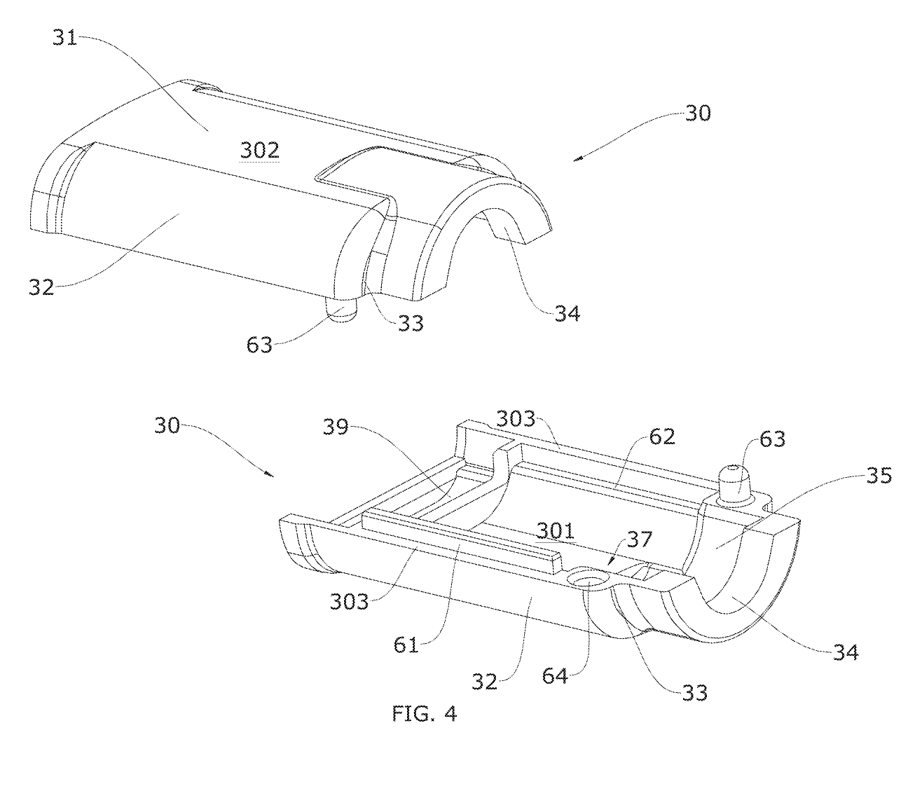

As best seen in FIG. 4, the alignment pin 63 protrudes from the first rear abutment 35 to a level above a height of the alignment rib 61 in this embodiment. Correspondingly, the alignment hole 64 is provided in the second rear abutment 37 in order to engage with the alignment pin 63 of other half the rear shielding shell 90. Therefore, the thrust at the first rear abutment 35 and the second rear abutment 37 will be restrained by the alignment pin 63 and the alignment hole 64 inside the outer surfaces 302. However, in other embodiments, the alignment pin 63 can protrude from the second rear abutment 37 and the alignment hole 64 is provided in the first rear abutment 35. In other words, the alignment pin 63 and the alignment hole 64 are interchangeably formed at the first rear abutment 35 the second rear abutment 37. The alignment pin 63 is able to lie on the first rear abutment 35 of other half the rear shielding shell 90 and engage with the alignment hole 64 of other half the rear shielding shell 90. In other words, the alignment pin 63 and the other alignment hole 64 will be inter-related into a fitting relationship and at the same time prevent relative movement between the coupling sections either laterally or endwise when the two halves 30 & 90 are brought together.

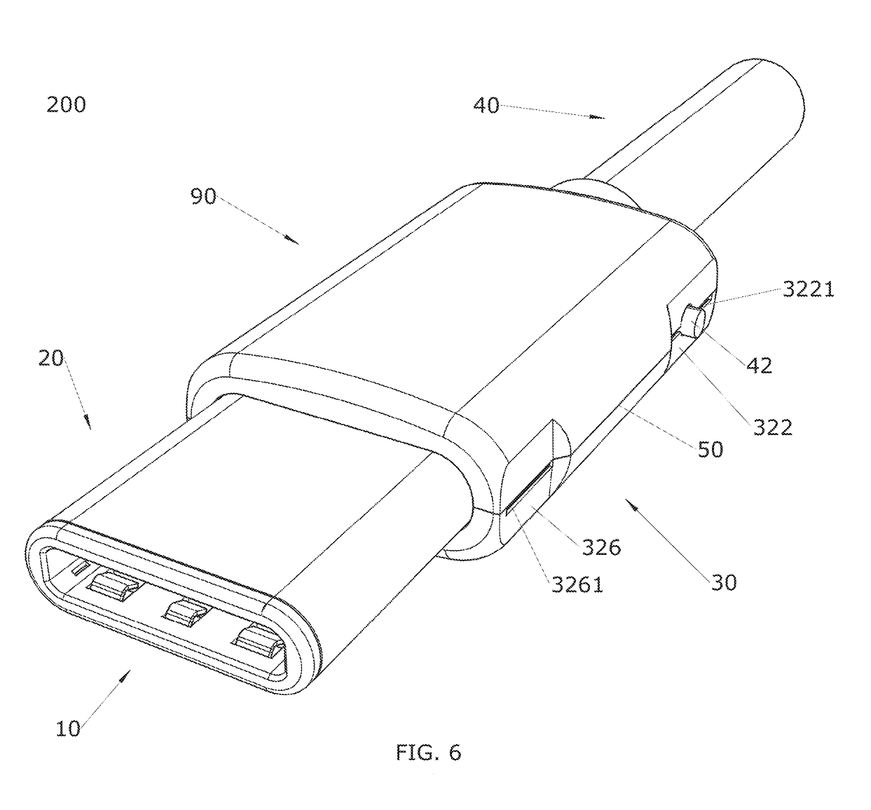

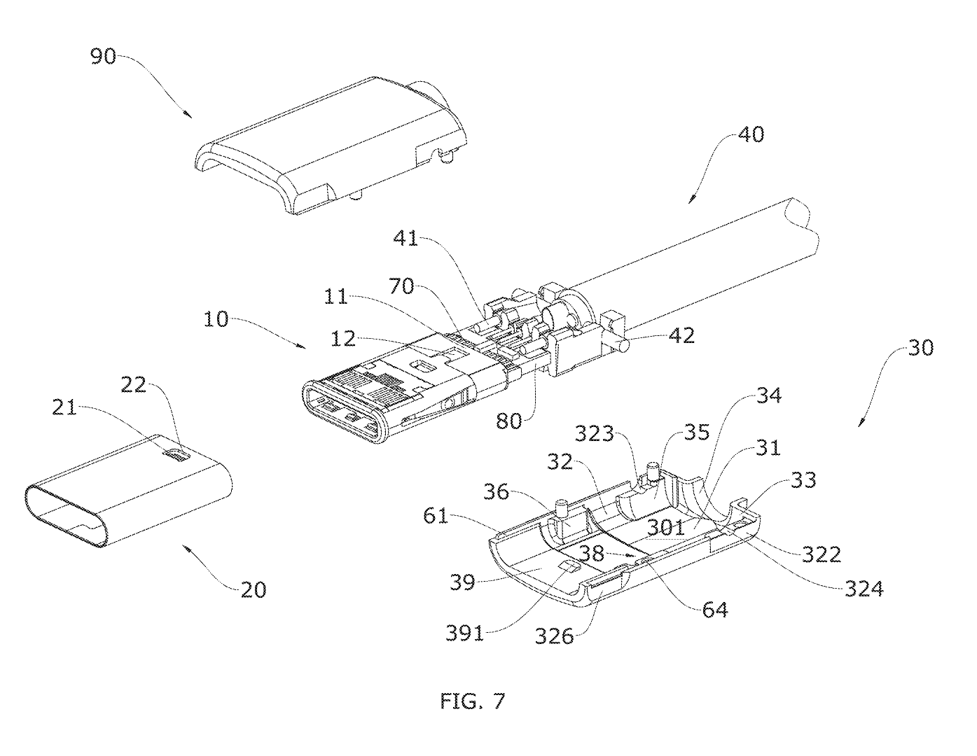

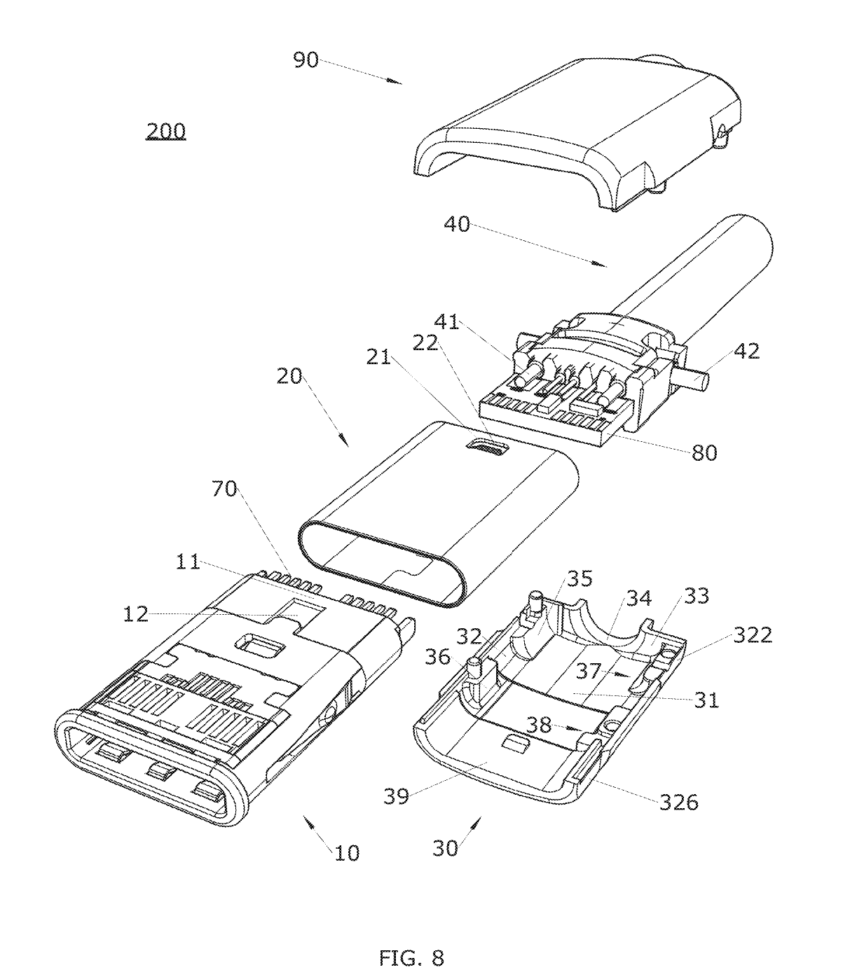

Reference is now made to FIGS. 6-8, which are perspective and exploded views of an electrical connector 200 according to the second embodiment of the present invention. This embodiment is similar to former one, and thus those identical to the former one will not be described further. Only the differences of the two are described. The front shielding shell 20 is fitted over and attached to the dielectric module 10 by means of two recessed latch tabs 21. The recessed latch tab 21 backwardly extend into the front shielding shell 20 and respectively away from retention features 22. In this embodiment, the retention features 22 are tow aperture 22 on both the top and bottom of the front shielding shell 20. When the dielectric module 10 is inserted as best seen in FIG. 8, a leading edge 211 of the latch tab 21 rides over a rear edge 11 of the dielectric module 10, causing the latch tab 21 to be resiliently deflected, until the leading edge 211 is positioned to enter a recess 12 in front of the rear edge 11.

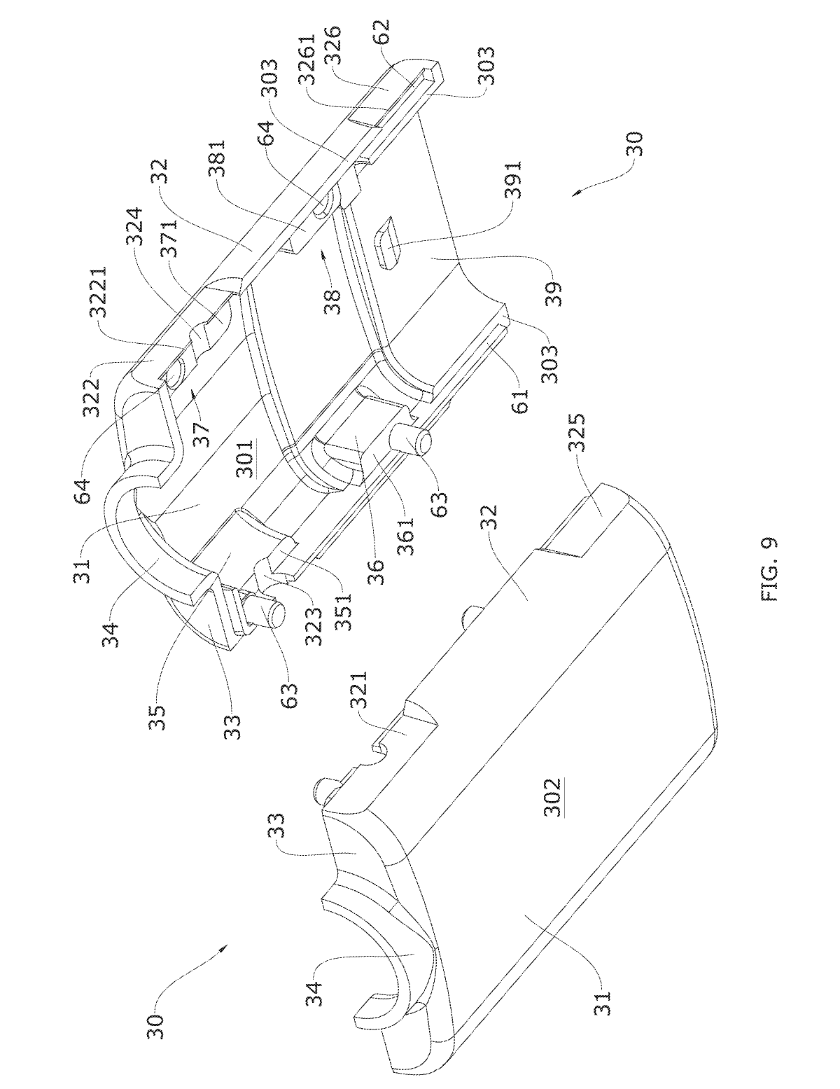

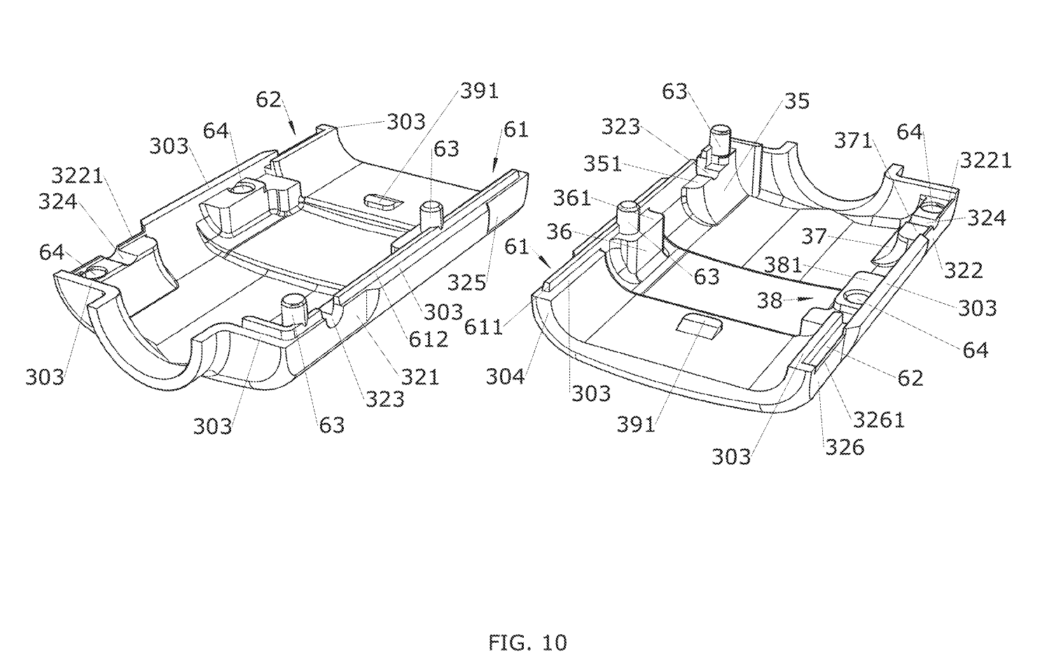

Reference is then made to FIGS. 9-10, which are perspective and exploded views of the rear shielding shell 30 according to the second embodiment of the present invention. A first middle abutment 36 and a second middle abutment 38 are formed at somewhere adjacent to the retaining portion 39 by inwardly protruding from the inner surfaces 301 at the two opposite side portions 32 respectively. Both a top surface 351 of the first rear abutment 35, a top surface 371 of the second rear abutment 37 and a top surface 381 of the second middle abutment 38 retreat to a sunken level from the coupling plane and therefore are below the level of the coupling surfaces 303. In contrast, a top surface 361 of the first middle abutment 36 is substantially even with the level of the coupling surfaces 303.

The hermaphroditic features include, as by molding, alignment ribs 61, an alignment groove 62, two alignment pins 63 and two alignment holes 64 in this embodiment. The alignment ribs 61 protrudes from and extends across most of the coupling surfaces 303 on one of the two opposite side portions 32 and the shoulder portion on the same side, while the alignment groove 62 is correspondingly provided on the opposite side. When the two halves 30 & 90 are brought together, part of the alignment ribs 61 will be positioned inside the alignment groove 62 of other half the rear shielding shell 90.

Furthermore, the alignment ribs 61 can further lean against both the second rear abutment 37 and the second middle abutment 38 of other half the rear shielding shell 90. In other words, the alignment ribs 61 can further lie on both the top surface 371 and the top surface 381 of other half the rear shielding shell 90. Additionally, outer surfaces 612 of the alignment ribs 61 will lie inside the inner surfaces 301 of other half the rear shielding shell 90 and, in turn, most of the alignment ribs 61 will be hidden in the rear shielding shell when the two halves 30 & 90 are combined with each other. Also noteworthy is that a front end 611 of the alignment ribs 61 retreats from a front end 304 of half the rear shielding shell 30, as best seen in FIG. 10, and will consequently be hidden behind the seams 50 when the two halves 30 & 90 are assembled.

Moreover, a retaining portion 39 with a bump 391 which engages with one retention feature 22 of the front shielding shell 20 is provided by increasing the thickness of half the rear shielding shell 30 at the forepart thereof from the inner surfaces 301. In this embodiment, the retention features 22 are two apertures 22 on top and bottom of the front shielding shell 20. The bump 391 on the retaining portion 39 is shaped to fill the aperture 22 and can further lean against the rear edge 11 or the recessed latch tab 21.

Additionally, a first rear recess 321 and a second rear recess 322 are provided by reducing the thickness of the two opposite side portions 32 from the outer surfaces 302 at the first rear abutment 35 and the second rear abutment 37. Similarly, a first front recess 325 and a second front recess 326 are provided by reducing the thickness of the two opposite side portions 32 from the outer surfaces 302 at the retaining portion 39. Moreover, both the second rear recess 322 and the second front recess 326 are respectively provided with a rear slit 3221 and a front slit 3261 by further removing the opposite side portion 32 respectively at the second rear abutment 37 and the alignment groove 62 from the level of the coupling surfaces 303. It is worthwhile mentioning that the alignment ribs 61 will be exposed to solder via the rear slit 3221 and the front slit 3261 when the two halves 30 & 90 are soldered to each other at the first rear recess 321, the second rear recess 322, the first front recess 325, and the second front recess 326.

Reference is still made to FIGS. 9-10. A first notch 323 and a second notch 324 are respectively cut in the first rear abutment 35 and the second rear abutment 37 and through the two opposite side portions 32, such that the first rear recess 321 and the second rear recess 322 can respectively communicate with the first notch 323 and the second notch 324. Therefore, lateral wires 42 of the cable 40 will be able to lie in the first notch 323 and the second notch 324 and then extend over the first rear recess 321 and the second rear recess 322 for later soldering. In this embodiment, the first rear recess 321 and the second rear recess 322 are profiled to be round. However, in other embodiments, the first rear recess 321 and the second rear recess 322 can be V-shaped or shaped as needed. When the two halves 30 & 90 are brought together, the first notch 323 will be combined with the second notch 324 of other half the rear shielding shell 90 to form a circular through hole via which the lateral wires 42 extend outward. In this embodiment, the first notch 323 in the first rear abutment 35 also cuts through the alignment ribs 61 and consequently splits the alignment ribs 61 into two sections which are supposed to be an integrated one.

The two alignment pins 63 respectively protrude from the first rear abutment 35 and the first middle abutment 36 to a level above a height of the alignment ribs 61. Correspondingly, the two alignment holes 64 are respectively provided in the second rear abutment 37 and the second middle abutment 38. When the two halves 30 & 90 are brought together, the two alignment pins 63 and the two alignment holes 64 of other half the rear shielding shell 90 will be inter-related into a fitting relationship and at the same time prevent relative movement between the coupling sections either laterally or endwise. In this embodiment, the two alignment holes 64 are buried holes and the two alignment pins 63 slightly intersect the alignment ribs 61.

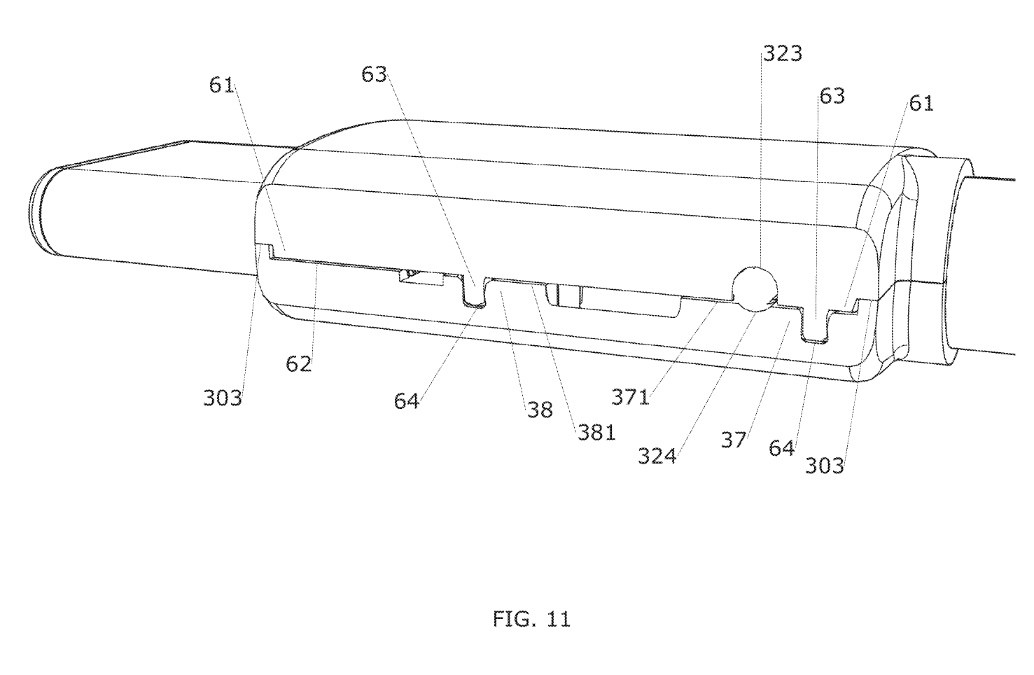

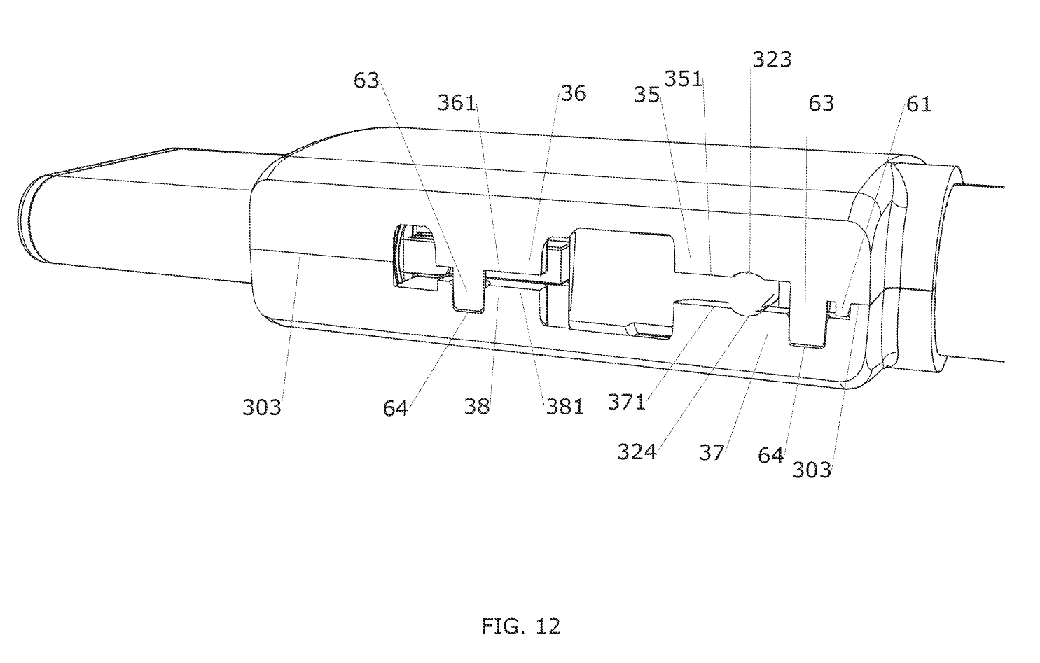

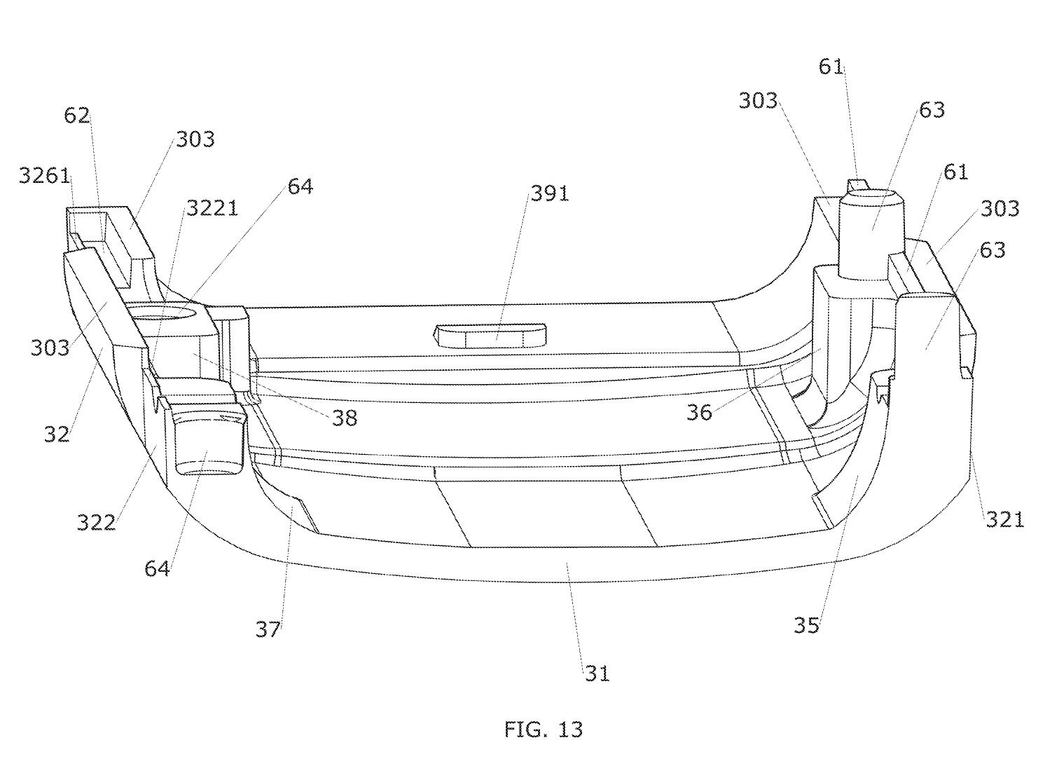

Reference is last made to FIGS. 11-13, which are cross-sectional views of the electrical connector 200 and half the rear shielding shell 30 according to the second embodiment of the present invention. A depth of the alignment groove 62 is substantially equal to the distance between the sunken level and the level of the coupling surfaces 303, while the height of the alignment ribs 61 is substantially equal to the depth of the alignment groove 62, as best seen in FIG. 11. The base portion 31, the two opposite side portions 32, the first rear abutment 35 and the second rear abutment 37 are shaped as a curved arch on the whole, as can be seen in FIG. 13. Therefore, external forces can be resolved into compressive stresses and, in turn eliminating tensile stresses. Subsequently, external forces in the rear shielding shell are carried to the ground, that is, the coupling surfaces 303, the top surface 351, the top surface 361, the top surface 371, and the top surface 381. The rear shielding shell comprised of two halves 30 & 90 will push outward at the ground, called the thrust. Then, the thrust at the ground will be restrained by the alignment ribs 61 and the alignment groove 62 inside the outer surfaces 302 as well as the two alignment pins 63 and the two alignment holes 64 inside the outer surfaces 302.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. All directional references (e.g., front, rear, side, top, bottom) are only used for identification purposes to aid the reader's understanding of the embodiments of the present invention, and do not create limitations, particularly as to the position, orientation, or use of the invention unless specifically set forth in the claims. Joinder references (that is, coupled, connected and the like) are to be construed broadly and may include relative movement between elements and intermediate members between a connection of elements. As such, joinder references do not necessarily infer that two elements are directly connected and in fixed relation to each other.

What is claimed is:

1. A rear shielding shell for surrounding a cable and holding a retention feature of a front shielding shell, wherein the front shielding shell is fitted over a dielectric module in which a plurality of contacts are embedded and the cable are electrically connected to the plurality of contacts via a paddle card, the rear shielding shell comprised of two halves and each half comprising:
a base portion;
two opposite side portions smoothly extending away from both sides of the base portion, wherein the two halves are combined with each other by hermaphroditic features inside outer surfaces thereof;
two shoulder portions extending away from rear ends of both the base portion and the two opposite side portions;
a collar portion by which the cable is surrounded, outwardly protruding from and between the two shoulder portions;
a first rear abutment and a second rear abutment being formed at somewhere adjacent to the two shoulder portions by inwardly protruding from inner surfaces at the two opposite side portions respectively, wherein the base portion, the two opposite side portions, the first rear abutment and the second rear abutment are shaped as a curved arch on the whole; and
a retaining portion engaging with the retention feature of the front shielding shell.

2. The rear shielding shell set forth in claim 1, each half further comprising a first notch and a second notch, wherein the first notch and the second notch are respectively cut in the first rear abutment and the second rear abutment and through the two opposite side portions.

3. The rear shielding shell set forth in claim 1, each half further comprising a first rear recess and a second rear recess, wherein the first rear recess and the second rear recess are provided by reducing the thickness of the two opposite side portions from the outer surfaces at the first rear abutment and the second rear abutment.

4. The rear shielding shell set forth in claim 3, wherein the second rear recess is provided with a rear slit by further removing the opposite side portion at the second rear abutment.

5. The rear shielding shell set forth in claim 1, each half further comprising a first front recess and a second front recess, wherein the first front recess and the second front recess are provided by reducing the thickness of the two opposite side portions from the outer surfaces at the retaining portion.

6. The rear shielding shell set forth in claim 5, wherein the second front recess is provided with a front slit by further removing the opposite side portion.

7. The rear shielding shell set forth in claim 1, wherein the rear shielding shell are two substantially identical halves and each half includes the hermaphroditic features.

8. The rear shielding shell set forth in claim 7, wherein the hermaphroditic features include an alignment pin and an alignment hole, wherein the alignment pin and the alignment hole are interchangeably formed at the first rear abutment and the second rear abutment.

9. The rear shielding shell set forth in claim 7, wherein the hermaphroditic features include an alignment rib and an alignment groove, wherein the alignment rib protrudes from the coupling surfaces on one of the two opposite side portions while the alignment groove is correspondingly provided on the coupling surfaces on the other of the two opposite side portions.

10. The rear shielding shell set forth in claim 9, wherein the alignment rib leans against the first rear abutment or the second rear abutment of other half the rear shielding shell.

11. An electrical connector, comprising:
a dielectric module;
a plurality of contacts embedded in the dielectric module;
a front shielding shell fitted over the dielectric module;
a cable being electrically connected to the plurality of contacts via a paddle card; and
a rear shielding shell, comprised of two halves and each half comprising:
a base portion;
two opposite side portions smoothly extending away from both sides of the base portion, wherein the two halves are combined with each other by hermaphroditic features inside outer surfaces thereof;
two shoulder portions extending away from rear ends of both the base portion and the two opposite side portions;
a collar portion by which the cable is surrounded, outwardly protruding from and between the two shoulder portions;
a first rear abutment and a second rear abutment being formed at somewhere adjacent to the two shoulder portions by inwardly protruding from inner surfaces at the two opposite side portions respectively, wherein the base portion, the two opposite side portions, the first rear abutment and the second rear abutment are shaped as a curved arch on the whole; and
a retaining portion engaging with the retention feature of the front shielding shell.

12. The electrical connector set forth in claim 11, each half further comprising a first notch and a second notch, wherein the first notch and the second notch are respectively cut in the first rear abutment and the second rear abutment and through the two opposite side portions.

13. The electrical connector set forth in claim 11, each half further comprising a first rear recess and a second rear recess, wherein the first rear recess and the second rear recess are provided by reducing the thickness of the two opposite side portions from the outer surfaces at the first rear abutment and the second rear abutment.

14. The electrical connector set forth in claim 13, wherein the second rear recess is provided with a rear slit by further removing the opposite side portion at the second rear abutment.

15. The electrical connector set forth in claim 11, each half further comprising a first front recess and a second front recess, wherein the first front recess and the second front recess are provided by reducing the thickness of the two opposite side portions from the outer surfaces at the retaining portion.

16. The electrical connector set forth in claim 15, wherein the second front recess is provided with a front slit by further removing the opposite side portion.

17. The electrical connector set forth in claim 11, wherein the rear shielding shell are two substantially identical halves and each half includes the hermaphroditic features.

18. The electrical connector set forth in claim 17, wherein the hermaphroditic features include an alignment pin and an alignment hole, wherein the alignment pin and the alignment hole are interchangeably formed at the first rear abutment and the second rear abutment.

19. The electrical connector set forth in claim 17, wherein the hermaphroditic features include an alignment rib and an alignment groove, wherein the alignment rib protrudes from the coupling surfaces on one of the two opposite side portions while the alignment groove is correspondingly provided on the coupling surfaces on the other of the two opposite side portions.

20. The electrical connector set forth in claim 19, wherein the alignment rib leans against the first rear abutment or the second rear abutment of other half the rear shielding shell.
